(19) United States
(12) Patent Application Publication
(10) Pub. No.: US 2005/0288004 A1
(43) Pub. Date: Dec. 29, 2005

(54) Wireless telecommunications method and mobile device for realizing the same

(75) Inventor: Chun-Hung Lin, Taipei City (TW)

Correspondence Address: Ladas & Parry, Suite 2100, 5670 Wilshire Boulevard, Los Angeles, CA, 90036-5679, US

(73) Assignee: COMPAL COMMUNICATIONS, INC.

(21) Appl. No.: 11/156,499

(22) Filed: Jun. 17, 2005

(30) Foreign Application Priority Data
Jun. 24, 2004 (TW) 093118292

(51) Int. Cl. H04M 3/00

(52) U.S. Cl. 455/418

(57) ABSTRACT

A wireless telecommunications method for transmitting and receiving data through a wireless telecommunications network that provides at least one of first and second data transmission services includes the steps of configuring a mobile device to determine whether the wireless telecommunications network provides both the first and second data transmission services; and when it is determined that the wireless telecommunications network provides both the first and second data transmission services, enabling operation of the mobile device for selecting one of the first and second data transmission services based on a pre-defined condition, and setting the selected one of the first and second data transmission services as a default data transmission service. A mobile device for realizing the method is also disclosed.

### CROSS-REFERENCE TO RELATED APPLICATION

This application claims priority of Taiwanese application no. 093118292, filed on Jun. 24, 2004.

### BACKGROUND OF THE INVENTION

1. Field of the Invention

This invention relates to a wireless telecommunications method and mobile device, more particularly to a wireless telecommunications method that enables operation of a mobile device to automatically select a data transmission service provided by a wireless telecommunications network.

2. Description of the Related Art

A conventional mobile phone accesses either a packet switched data (PSD) transmission service or a circuit switched data (CSD) transmission service provided by a wireless telecommunications network during a dial-up internet connection.

Although the service coverage of the CSD transmission service is wider than that of the PSD transmission service, the transmission rate of the CSD transmission service is slower than that of the PSD transmission service. As such, since the access fee is time-related, the CSD transmission service costs more than the PSD transmission service.

It is desirable to provide a mobile phone that is capable of automatically selecting the PSD transmission service over the CSD transmission service when both services are provided by the wireless telecommunications network.

### SUMMARY OF THE INVENTION

According to one aspect of the present invention, a wireless telecommunications method for transmitting and receiving data through a wireless telecommunications network that provides at least one of first and second data transmission services comprises the steps of:
configuring a mobile device to determine whether the wireless telecommunications network provides both the first and second data transmission services; and
when it is determined that the wireless telecommunications network provides both the first and second data transmission services, enabling operation of the mobile device for
   selecting one of the first and second data transmission services based on a pre-defined condition, and
   setting the selected one of the first and second data transmission services as a default data transmission service.

According to another aspect of the present invention, a mobile device for a wireless telecommunications network that provides at least one of first and second data transmission services comprises a detector module that determines whether the wireless telecommunications network provides both the first and second data transmission services, and that is operable so as to select one of the first and second data transmission services based on a pre-defined condition when the detector module determines that the wireless telecommunications network provides both the first and second data transmission services and so as to set the selected one of the first and second data transmission services as a default data transmission service.

### BRIEF DESCRIPTION OF THE DRAWINGS

Other features and advantages of the present invention will become apparent in the following detailed description of the preferred embodiment with reference to the accompanying drawings, of which:

FIG. 1 is a simplified block diagram of the preferred embodiment of a mobile device according to the present invention; and

FIGS. 2A to 2C are flowcharts to illustrate the preferred embodiment of a wireless telecommunications method according to the present invention.

### DETAILED DESCRIPTION OF THE PREFERRED EMBODIMENT

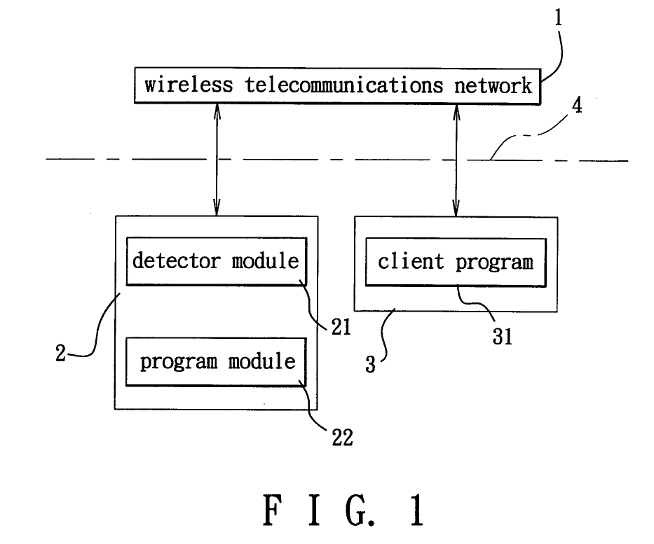

Referring to FIG. 1, the preferred embodiment of a mobile device 2 for a wireless telecommunications network 1 according to this invention is shown to include a detector module 21 and a program module 22.

In this embodiment, the mobile device 2 is embodied in a mobile phone.

The wireless telecommunications network 1 may provide either a first or a second data transmission service, or both the first and second data transmission services. In this embodiment, the first data transmission service is a packet switched data (PSD) transmission service, whereas the second data transmission service is a circuit switched data (CSD) transmission service.

The wireless telecommunications network 1 further permits data transmission with a client side 3, such as another mobile phone. In an alternative embodiment, the client side 3 may be a computer.

The wireless telecommunications network 1 provides the first and second data transmission services to the mobile device 2 and the client side 3 through an air interface 4 in a conventional manner.

The mobile device 2 establishes a client side connection with the client side 3 through the wireless telecommunications network 1, and accesses either the first or second data transmission service for exchanging information with the client side 3, in a manner that will be described in greater detail hereinafter.

The detector module 21 of the mobile device 2 is configured to determine whether the wireless telecommunications network 1 provides both the first and second data transmission services, or only one of the first and second data transmission services. In this embodiment, the detector module 21 of the mobile device 2 is operable so as to select one of the first and second data transmission services based on a pre-defined condition when the detector module 21 of the mobile device 2 determines that the wireless telecommunications network 1 provides both the first and second data transmission services, and so as to set the selected one of the first and second data transmission services as the default data transmission service. It is noted that the pre-defined condition is both speed-related and cost-related.

In this embodiment, the detector module 21 of the mobile device 2 sets the first data transmission service as the default data transmission service when the detector module 21 of the mobile device 2 determines that the wireless telecommunications network 1 provides only the first data transmission service. On the other hand, the detector module 21 of the mobile device 2 sets the second data transmission service as the default data transmission service when the detector module 21 of the mobile device 2 determines that the wireless telecommunications network 1 provides only the second data transmission service.

The program module 22 of the mobile device 1 is coupled to the detector module 21 of the mobile device and is loaded with a server socket program 22.

The client side 3 is loaded with a client program 31 for enabling the client side 3 to initiate connection with the mobile device 2 through the wireless telecommunications network 1. The client program 31 of the client side 3 further enables the client side 3 to initiate connection with a web server (not shown) for an internet access through the wireless telecommunications network 1 in a conventional manner.

When the detection module 21 of the mobile device 2 sets the second data transmission service, i.e., the CSD transmission service, as the default data transmission service, the program module 22 of the mobile device 2 verifies a connection request received through the wireless telecommunications network 1, and establishes the client side connection only upon successful verification.

It is noted that the detector module 21 and the program module 22 of the mobile device 2 operate automatically.

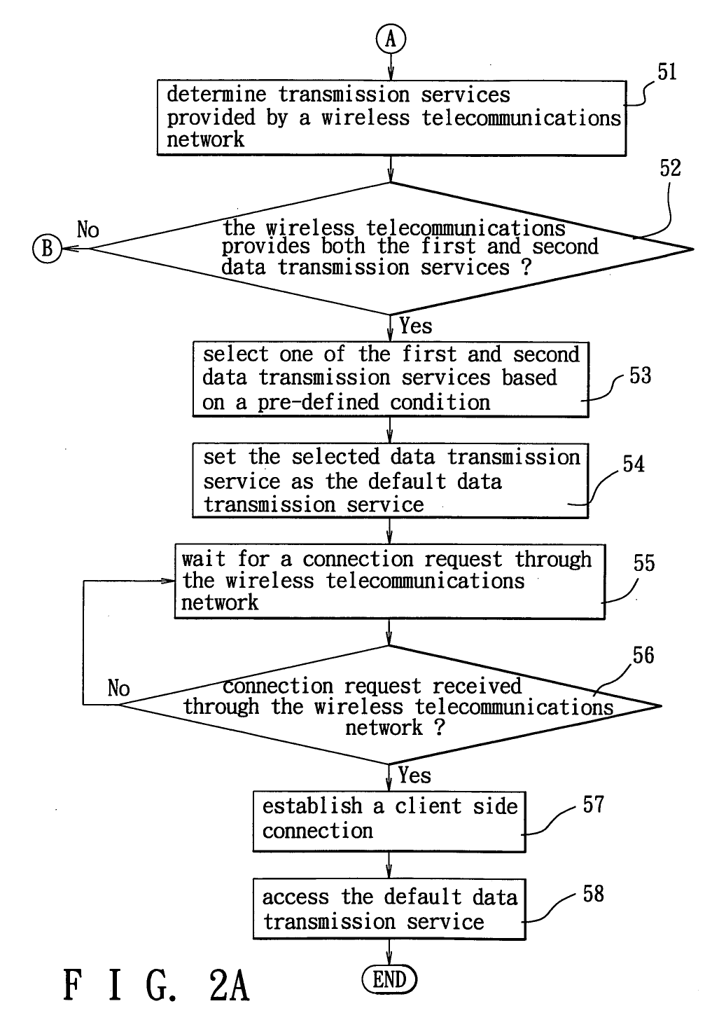

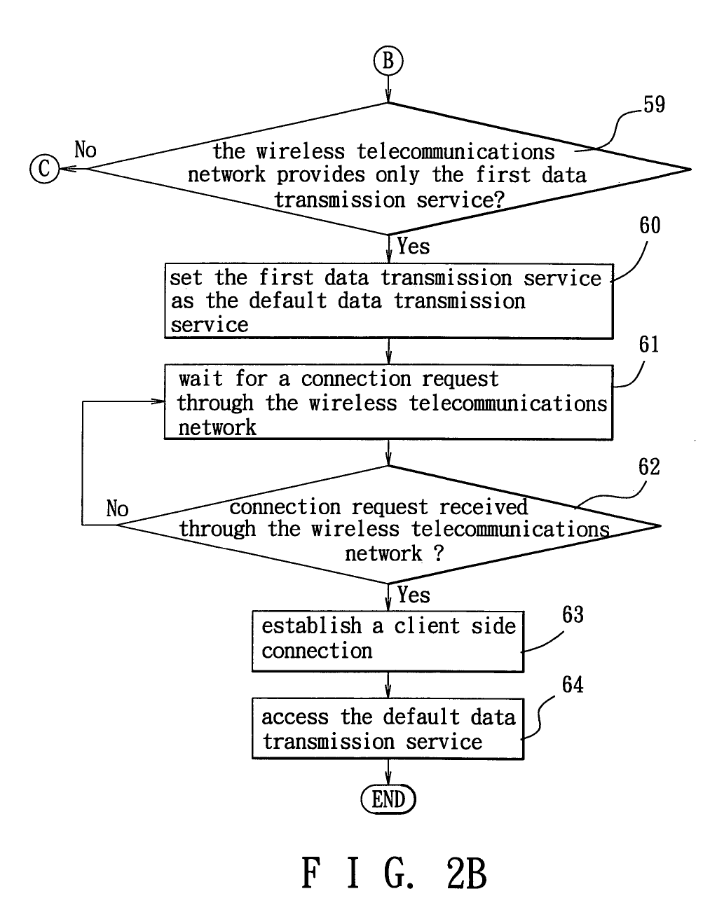

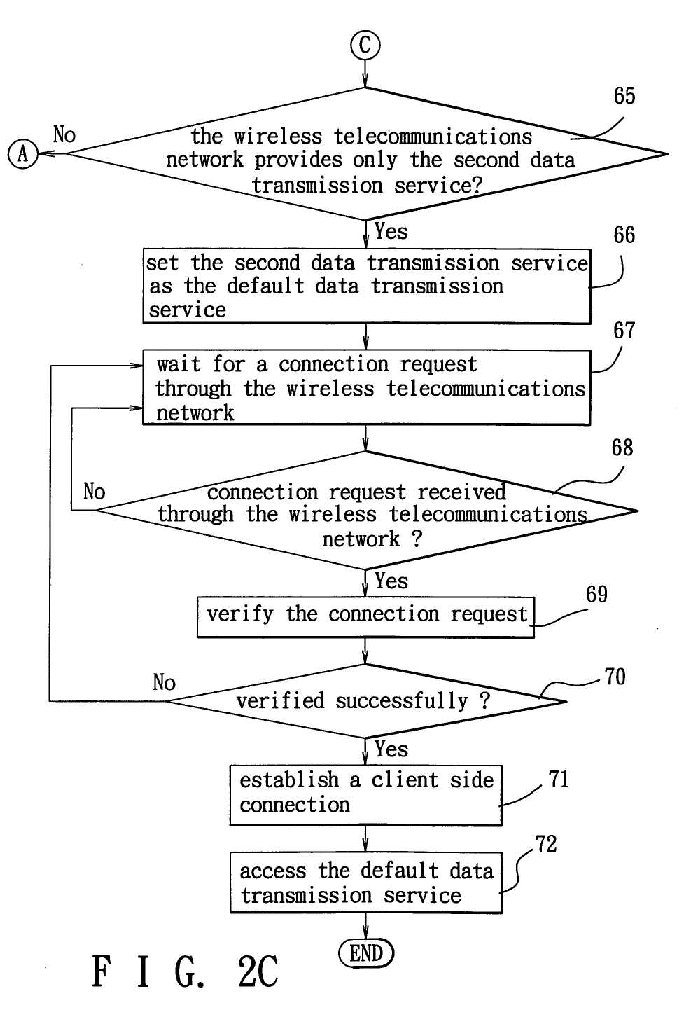

The preferred embodiment of a wireless telecommunications method for transmitting and receiving data through the wireless telecommunications network 1 according to this invention will now be described with further reference to FIGS. 2A to 2C.

In step 51, the detector module 21 of the mobile device 2 determines whether the wireless telecommunications network 1 provides both the first and second data transmission services.

In step 52, when it is determined, by the detector module 21, that the wireless telecommunications network 1 provides both the first and second data transmission services, the flow proceeds to step 53. Otherwise, the flow proceeds to step 59.

In step 53, the detector module 21 of the mobile device 2 selects one of the first and second data transmission services based on a pre-defined condition.

In this embodiment, since the pre-defined condition is both speed- and cost-related, the detector module 21 of the mobile device 2 selects the first data transmission service (i.e., the packet switched data transmission service).

In step 54, the detector module 21 sets the first data transmission service as the default data transmission service. Thereafter, in step 55, the program module 22 of the mobile device 2 waits for a connection request through the wireless telecommunications network 1.

In step 56, when the program module 22 of the mobile device 2 receives the connection request through the wireless telecommunications network 1, the flow proceeds to step 57. Otherwise, the flow goes back to step 55.

It is noted that the connection request is preferably in the form of a short message service that contains an internet protocol (IP) address of the client side 3.

In step 57, the program module 22 of the mobile device 2 establishes the client side connection. Thereafter, in step 58, the program module 22 of the mobile device 2 accesses the default data transmission service, i.e., the PSD transmission service.

In step 59, when it is determined, by the detector module 21 of the mobile device 2, that the wireless telecommunications network 1 provides only the first data transmission service, the flow proceeds to step 60. Otherwise, the flow proceeds to step 65.

In step 60, the detector module 21 sets the first data transmission service as the default data transmission service. Thereafter, in step 61, the program module 22 of the mobile device 2 waits for a connection request through the wireless telecommunications network 1.

In step 62, when the program module 22 of the mobile device 2 receives the connection request through the wireless telecommunications network 1, the flow proceeds to step 63. Otherwise, the flow goes back to step 61.

In step 63, the program module 22 establishes the client side connection. Thereafter, in step 64, the program module 22 accesses the default data transmission service, i.e., the PSD transmission service.

In step 65, when it is determined, by the detector module 21 of the mobile device 2, that the wireless telecommunications network 1 provides only the second data transmission service, i.e. the CSD transmission service, the flow proceeds to step 66. Otherwise, the flow goes back to step 51.

In step 66, the detector module 21 of the mobile device 2 sets the second data transmission service as the default data transmission service. Thereafter, in step 67, the program module 22 of the mobile device 2 waits for a connection request through the wireless telecommunications network 1.

In step 68, when the program module 22 of the mobile device 2 receives the connection request through the wireless telecommunications network 1, the flow proceeds to step 69. Otherwise, the step goes back to step 67.

In step 69, the program module 22 of the mobile device 2 verifies the connection request. Verification is made possible through the comparison with a database of valid clients stored in the mobile device 2. In an alternative embodiment, verification can be done manually by the user of the mobile phone 2.

In step 70, if the program module 22 of the mobile device 2 successfully verifies the connection request, the flow proceeds to step 71. Otherwise, the flow goes back to step 67.

In step 71, the program module 22 of the mobile device 2 establishes the client side connection. Thereafter, in step 72, the program module 22 of the mobile device 2 accesses the default data transmission service, i.e., the CSD transmission service.

It is noted that the aforementioned steps of the wireless telecommunications method of this invention are performed automatically by the detector module 21 and the program module 22 of the mobile device 2.

It has thus been shown that this invention permits automatic solution of the PSD transmission service over the CSD transmission service when both services are available to result in lower access cost. In addition, because connection requests can be screened through the verification mechanism when only the CSD transmission service is available, access costs can be further reduced in the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A wireless telecommunications method for transmitting and receiving data through a wireless telecommunications network that provides at least one of first and second data transmission services, said wireless telecommunications method comprising the steps of:
configuring a mobile device to determine whether the wireless telecommunications network provides both the first and second data transmission services; and
when it is determined that the wireless telecommunications network provides both the first and second data transmission services, enabling operation of the mobile device for
selecting one of the first and second data transmission services based on a pre-defined condition, and
setting the selected one of the first and second data transmission services as a default data transmission service.

2. The wireless telecommunications method as claimed in claim 1, further comprising the step of:
when it is determined that the wireless telecommunications network provides only one of the first and second data transmission services, enabling operation of the mobile device for setting the determined one of the first and second data transmission services as the default data transmission service.

3. The wireless telecommunications method as claimed in claim 1, wherein the pre-defined condition is cost-related.

4. The wireless telecommunications method as claimed in claim 1, wherein the pre-defined condition is speed-related.

5. The wireless telecommunications method as claimed in claim 1, wherein the first data transmission service is a packet switched data service.

6. The wireless telecommunications method as claimed in claim 1, wherein the second data transmission service is a circuit switched data service.

7. The wireless telecommunications method as claimed in claim 1, wherein the first data transmission service is a packet switched data service, and the second data transmission service is a circuit switched data service.

8. The wireless telecommunications method as claimed in claim 7, further comprising the steps of:
when the mobile device sets the second data transmission service as the default data transmission service, in response to a connection request received through the wireless telecommunications network, enabling operation of the mobile device for
verifying the connection request,
establishing a client side connection upon successful verification, and
accessing the default data transmission service.

9. The wireless telecommunications method as claimed in claim 8, wherein the connection request is in the form of a short message service that contains internet protocol address of a client side.

10. The wireless telecommunications method as claimed in claim 1, wherein the mobile device is a mobile phone.

11. The wireless telecommunications method as claimed in claim 2, wherein the steps are performed automatically.

12. The wireless telecommunications method as claimed in claim 8, wherein the steps are performed automatically.

13. A mobile device for a wireless telecommunications network that provides at least one of first and second data transmission services, said mobile device comprising:
a detector module adapted to determine whether the wireless telecommunications network provides both the first and second data transmission services, and operable so as to select one of the first and second data transmission services based on a pre-defined condition when said detector module determines that the wireless telecommunications network provides both the first and second data transmission services and so as to set the selected one of the first and second data transmission services as a default data transmission service.

14. The mobile device as claimed in claim 13, wherein said detector module is further operable so as to set the determined one of the first and second data transmission services as a default data transmission service when said detector module determines that the wireless telecommunications network provides only one of the first and second data transmission services.

15. The mobile device as claimed in claim 13, wherein the first data transmission service is a packet switched data service, whereas the second data transmission service is a circuit switched data service.

16. The mobile device as claimed in claim 15, further comprising a program module that is coupled to said detector module, that is loaded with a server socket connection program, and that is operable so as to verify a connection request received from the wireless telecommunications network, so as to establish a client side connection upon successful verification, and so as to access the default data transmission service when it is determined that the wireless telecommunications network provides only the second data transmission service.

17. The mobile device as claimed in claim 13, wherein said mobile device is a mobile phone.

18. The mobile device as claimed in claim 13, wherein the pre-defined condition is speed-related.

19. The mobile device as claimed in claim 13, wherein the pre-defined condition is cost-related.

20. The mobile device as claimed in claim 14, wherein said detector module operates automatically.

21. The mobile device as claimed in claim 16, wherein said detector module and said program module operate automatically.
